(19) United States
(12) Patent Application Publication
(10) Pub. No.: US 2005/0018596 A1
(43) Pub. Date: Jan. 27, 2005

(54) System for crosstalk noise reduction on twisted pair, ethernet, polyphase and shielded wire systems

(76) Inventors: Robert Washburn, Malibu, CA (US); Robert McClanahan, Valencia, CA (US)

Correspondence Address: COUDERT BROTHERS LLP, 333 SOUTH HOPE STREET, 23RD FLOOR, LOS ANGELES, CA, 90071, US

(21) Appl. No.: 10/871,157

(22) Filed: Jun. 18, 2004

Related U.S. Application Data
(60) Provisional application No. 60/479,702, filed on Jun. 19, 2003.

(51) Int. Cl. H04J 1/12

(52) U.S. Cl. 370/201

(57) ABSTRACT

The present invention is an electronic circuit that reduces crosstalk in communications systems employing twisted pair, Ethernet, polyphase or shielded wire transmission media. The present invention includes three stages of crosstalk noise reduction. Stage 1 filters common mode noise from the transmission media and balances the resistive and reactive parasitic electrical characteristics of the transmission media that couple each line to the local ground over the operating frequency band. The second Stage performs differential crosstalk noise reduction in real time using multiple feedback loops. It can dynamically locate and set optimal system operating conditions for minimal differential crosstalk coupling for the specific environmental and interfering channel utilization conditions. The third Stage utilizes digital signal processing techniques to further reduce any residual crosstalk after analog-to-digital conversion. The third Stage also functions as a digital controller for the entire system as well as portions of subsystems including the feedback loops of Stage 2.

### RELATED APPLICATION

This application claims priority to U.S. Provisional Patent Application No. 60/479,702, filed Jun. 19, 2003, the disclosure of which is hereby fully incorporated by reference.

### BACKGROUND OF THE INVENTION

1. Field of the Invention

The present invention relates generally to crosstalk noise reduction. More specifically it relates to crosstalk noise reduction on twisted pair, Ethernet, polyphase, and shielded wire systems.

2. Background Art

Crosstalk is the interference (noise) generated in a communications channel from other communications channels. The crosstalk generating interference (noise) from the other communications channels is comprised of both signals and noise present on the other channels. Crosstalk has been characterized in a variety of ways depending upon its form, impact, and the nature and location of the interfering signal coupling process. Some examples of note are Near End Cross Talk (NEXT) where the interfering transmitters and receiver are at the same end of a communications link, and Far End Cross Talk (FEXT) where they are at opposite ends.

Crosstalk in telecommunication systems using wire transmission media has been a problem since telephone calls were first switched and routed at a central location through bundled wire pairs and cables. When the most critical form of communication was voice telephony, the major concern was intelligible crosstalk where a user would hear a “foreign” conversation. This was much more significant than merely having elevated noise on the line as it was more distracting and raised questions as to who might be listening to what the user was communicating. Thus systems were designed to provide less than a 1% chance of a user encountering an intelligible “foreign” conversation based on statistical test data. This translated to a specified crosstalk ratio at audio frequency of not less than 58 dB for 90% of all two-circuit combinations. It is somewhat ironic that having more lines in a bundle actually in use reduced the intelligibility of the crosstalk even though it increased the total crosstalk noise power being coupled into the user's line.

Utilization of such lines for broadband applications such as high-speed, high-volume data transmission requires much greater signal-to-noise ratios including crosstalk noise. As described by the title, the crosstalk noise reduction system of the present invention is generally applicable and beneficial wherever crosstalk can occur. The remaining discussion will be directed toward digital subscriber line (XDSL) applications since these suffer the greatest disparity between potential and realized performance and lack some of the most significant crosstalk control tools such as individual wire pair shields. In such discussions, reference will be made to standard “Spectrum Compatibility T1. 417” published as an American National Standards Institute (ANSI) Standard in September 2003. Particular emphasis will be made to statements from unreleased draft revision 2 issued in February 2003 as being reflective of the latest consensus industry, academic, and professional understanding of the issues, problems and requirements. On page 113, it states: “For digital communication via digital subscriber line technology, where the signal bandwidth reaches into the MHz range, the crosstalk is a limiting factor to the achievable throughput. ”

Prior Art Attempts at Controlling Crosstalk

The primary means of controlling crosstalk was and largely remains selection of the wire and its characteristics. Wire size and insulation thickness have always been major factors in establishment of the level of crosstalk noise power and form the basis for meeting coupling standards. As stated in T1. 417, “In general the effect of cable crosstalk is minimized not only by the use of good insulation material between pairs but also by adapting different twist distances among different pairs in a binder group. The binder groups are also twisted such that no two groups are adjacent for long runs. ” The major difficulty here is that most xDSL lines are not new installations but are old, low frequency telephone lines with the compensation cokes (typically 88 mH) removed. Replacement of millions of miles of existing wiring would be extremely expensive and remove the primary competitive advantage of xDSL over cable or wireless, that the transmission media is already in place and each line can make full use of the full available xDSL system allocated bandwidth (if crosstalk and other variations can be controlled.

Other than the selection of wire characteristics, the primary contribution to crosstalk control is the use of echo cancellation techniques. These were initially developed to accommodate long propagation times. Per T1. 417, “Two-to-four-wire hybrid circuits that act as balanced bridge networks perform the first level of separation between transmit and receive signals. Ten to twenty dB of isolation can be achieved with active and passive analog compromise balance impedance networks. Digital echo cancellers can provide 30 to 40 dB of additional isolation. ”

Drawbacks of Conventional Systems

One of the main problems with conventional echo cancellation crosstalk noise reduction techniques is that they almost exclusively try to deal with the crosstalk after it gets into the digital part of the system. First, the crosstalk noise is converted to digital form, a process that can consume a significant portion of the dynamic range of the analog to digital converter (A/D). Second, the encoding schemes that are used to extract the signal from the noise operate on a statistical basis. Since the schemes are statistical in nature and not deterministic, they suffer from a significant intrinsic limitation on achievable performance.

Although wire characteristics and echo cancellation are the major contributors to crosstalk control in the present art, additional sources are being addressed. One example is the use of resistors to balance the resistance from each line to ground (referred to as longitudinal balance) as illustrated by Evans, et. al. in U.S. patent application 20020159548. As pointed out, such a DC balance is beneficial. However, it is far from sufficient since the coupling is frequency dependent and includes capacitive and even some inductive coupling with and through the local ground.

A major problem with digital crosstalk control schemes is that they have come to dominate the approach to crosstalk control. This effectively limits progress to realization of improved algorithms, faster signal processing hardware, faster dynamic memory access, and higher resolution, higher speed D/A and A/D converters. Progress, particularly in the area of high resolution D/A and A/D converters has not been sufficient to provide major improvements in real world performance. Thus crosstalk remains the controlling limitation on the performance of xDSL systems, particularly for full duplex systems wherein available bandwidth utilization is maximized.

In addition to the above major problems, the focus on digital crosstalk control has led to erroneous conclusions and a general ignoring of alternate analog and mixed signal systems and approaches. This can be seen in T1. 417 where the proposed standard states: “ . . . full duplex communication on a single pair is achieved by the use of the echo cancellation technique. This requires transmitted and received signal paths be as fully separated as practical with signal processing techniques even though transmitted and received signals share the same frequency spectra. However, transmitted signals in other adjacent pairs are not available to the particular receiver. Thus, any energy coupled into a pair used by a transmission system cannot be effectively removed from the received signal. ” Fortunately, this erroneous and limiting assessment of analog-based crosstalk reduction means can be overcome. The present invention performs exactly this function and will reduce crosstalk by substantially greater than 20 dB compared to the presently available art. Furthermore, the present invention can be applied to future, extended band, xDSL systems presently being proposed.

This does not imply that digital suppression is not a valuable tool for crosstalk noise control. In fact, this type of suppression plus other digital signal processing techniques constitute a portion of Stage 3 of the present invention. In general, improvements provided by the present invention help overcome standard's neglect of analog-based crosstalk reduction means and thereby further advances the state of the art in crosstalk reduction in xDSL system.

### SUMMARY OF THE INVENTION

In view of the foregoing disadvantages and limitations inherent in the known types of crosstalk noise reduction systems present in the prior art, the present invention provides a new crosstalk noise reduction system for communications systems employing twisted pair, Ethernet, polyphase and shielded wire transmission media.

The primary purpose of the present invention, which will be described subsequently in greater detail, is to provide a new crosstalk noise reduction means on twisted pair, Ethernet, polyphase, and shielded wires that has many of the advantages of the crosstalk noise reduction mentioned heretofore and many novel features that result in a new crosstalk noise reduction system on twisted pair, Ethernet, polyphase and shielded wire transmission media which is not anticipated, suggested, implied or rendered obvious, by any of the crosstalk noise reduction means of the prior art, either alone or in any combination thereof.

To realize this purpose, the present invention generally comprises three stages of crosstalk noise reduction. Stage 1 primarily utilizes passive components to balance parasitic resistance and capacitance from each transmission media conductor to ground and to substantially reduce common mode noise present on the transmission media conductors. Stage 2 primarily uses active electronic circuitry in the form of a type I feedback control loop to remove differential crosstalk noise from the analog receive signal. Stage 3 primarily uses digital signal processing techniques to further remove crosstalk noise from the receive signal after conversion to digital form.

The more important features of the invention have thus been broadly outlined in order that the detailed description thereof may be better understood, and that the contribution to the present art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

One embodiment of the present invention is an crosstalk noise reduction system comprising, a first stage, which comprises passive crosstalk noise reduction circuits operating on signals from a transmission media; a second stage, which comprises active crosstalk noise reduction circuits and multiple feedback loops; and a third stage, which comprises a digital signal processor.

In one or more embodiments, the first stage of crosstalk noise reduction system is configured to filter common mode noise from a transmission media and balance the resistive and reactive parasitic electrical characteristics of said transmission media that couple each line.

In one or more embodiments, the second stage of crosstalk noise reduction system is configured to perform differential crosstalk noise reduction in real time.

In one or more embodiments, the third stage of crosstalk noise reduction system is configured to reduce residual crosstalk after analog-to-digital conversion.

In one or more embodiments, the third stage of crosstalk noise reduction system digitally controls the crosstalk noise reduction system and portions of subsystems of the second stage.

In one or more embodiments, the third stage of crosstalk noise reduction system uses two inputs from the first and second stage to adjust control signals sent to calibrate components in said second stage. The first of the two inputs is from an A/D converter converting a receiving signal from in transmission media and the second of the two inputs is from an A/D converter converting a common mode signal in the transmission media.

In one or more embodiments, the second stage of crosstalk noise reduction system comprises: a common mode sense; an A/D converter; a first amplifier receiving output signal from said common mode sense; a second amplifier receiving output signal from said common mode sense; and a synchronous AM detector.

In one or more embodiments, the second stage of crosstalk noise reduction system further comprises a summing node configured to use output from the second amplifier to cancel crosstalk noise in a receiving signal from said transmission media.

In one or more embodiments, the second stage of crosstalk noise reduction system further comprises an AGC control configured to receive control signals from the third stage to control the second amplifier.

In one or more embodiments, the present invention reduces the crosstalk noise in the receive signal before it is digitized by the analog-to-digital converter.

In one or more embodiments, the present invention suppresses or reduces line-to-ground impedance mismatch on twisted pair, Ethernet, poly phase and shielded wire systems as opposed to simple resistive mismatch correction occasionally implemented within the present art.

In one or more embodiments, the present invention balances the line-to-line currents in twisted pair, Ethernet, polyphase and shielded wire transmission media systems.

In one or more embodiments, the present invention performs a digital cross correlation between digitized common mode and digitized differential mode signals and digitally subtracts the remaining common mode to differentially converted signal.

In one or more embodiments, the present invention detects the common mode to differential conversion signal ratios that occur on a twisted pair, Ethernet, polyphase or shielded wire system and subtracts the scaled differential crosstalk noise component from the receiver output signal in real time.

Other objects and advantages of the present invention will become obvious to the reader and it is intended that these objects and advantages are within the scope of the present invention.

For accomplishment of the above and related objectives, the present invention may be embodied in the form illustrated in the accompanying drawings. However, the drawings are illustrative only, and changes may be made in the specific construction and terminology illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of a typical ADSL communications system.

FIG. 2 is a circuit diagram representing a typical twisted pair line adjacent to a second twisted pair line, illustrating means for crosstalk noise coupling among the four wires.

FIG. 3 is a block diagram of the crosstalk noise reduction system of the present invention illustrating the relationship among the three stages of crosstalk noise reduction.

FIG. 4 is a block diagram of the crosstalk noise reduction system of the present invention.

FIG. 5 is a circuit diagram of Stage 1 of the crosstalk noise reduction system of the present invention.

FIG. 6 is a circuit diagram of an embodiment of the common mode sense function of Stage 2 of the crosstalk noise reduction system of the present invention.

FIG. 7 is a circuit diagram of the synchronous AM detection function of Stage 2 of the crosstalk noise reduction system of the present invention.

FIG. 8 is a circuit diagram of the low pass filter function of Stage 2 of the crosstalk noise reduction system of the present invention.

FIG. 9 is a block diagram of the AGC function for the crosstalk correction amplifier of Stage 2 of the crosstalk noise reduction system of the present invention.

FIG. 10 is a circuit diagram of the AGC control function of Stage 2 of the crosstalk noise reduction system of the present invention.

### DETAILED DESCRIPTION OF THE INVENTION

The present invention is directed to crosstalk noise reduction on twisted pair, Ethernet, polyphase and shielded wire systems that will overcome the shortcomings of prior art devices. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Differential crosstalk noise coupled into twisted pair xDSL (Digital Subscriber Line) lines significantly reduces the signal-to-noise ratio of the system and is one of the most significant barriers limiting real world reach and data transfer performance of DSL systems. The present invention enables electronic circuit designers of systems using twisted pair, Ethernet, polyphase or shielded wire signal transmission media to both reduce the level of differential crosstalk noise coupling, and remove a major portion of any residual differential crosstalk noise present on the received signal prior to conversion of the receive signal to digital format for processing by a Digital Signal Processor (DSP).

Implementation of the present invention is described for an Asynchronous Digital Subscriber Line (ADSL) system as this represents to most common form of DSL in present use. The present invention is even more effective for symmetric or full duplex systems forms where bi-directional signal transfer occurs in the same or overlapping frequency bands. Such systems can make maximum effective use of available bandwidth but are more susceptible and vulnerable to coupling of differential crosstalk noise.

Basic ADSL Communications System

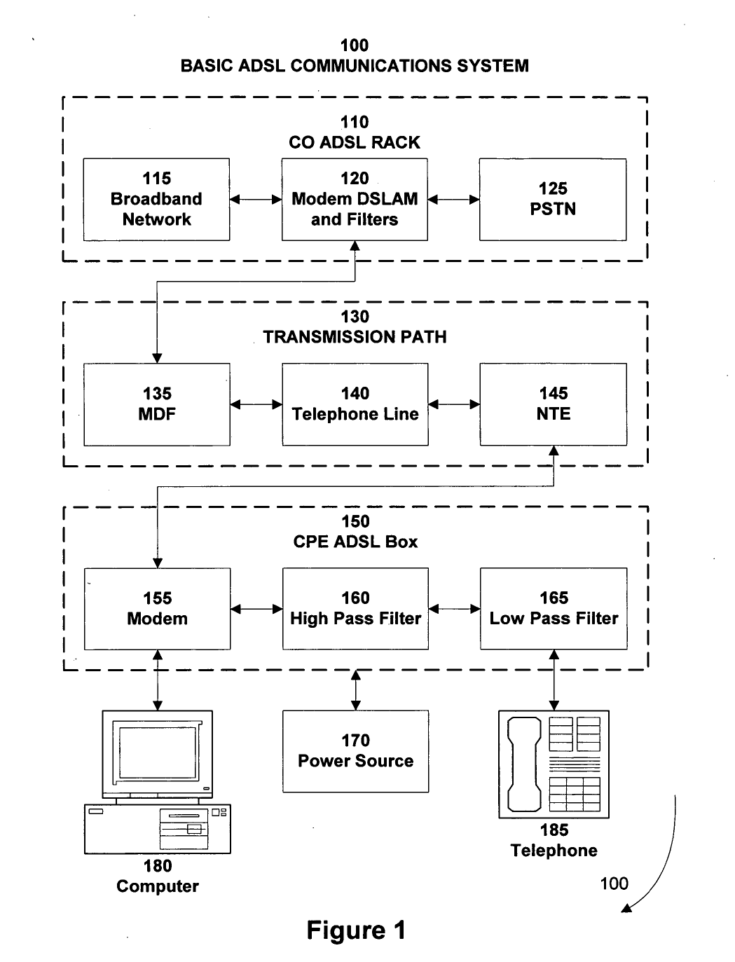

FIG. 1 is an illustration 100 of the functional elements and their interrelationships for a typical ADSL communications system. Such ADSL system will be used to illustrate the functionality and implementation of embodiments of the present invention. Central Office (CO) ADSL rack 110 represents the central distribution point or “central office” for the ADSL service provider. Principle components of CO ADSL rack 110 are broadband network 115, Digital Subscriber Line Access Multiplexer (DSLAM) 120, and PTSN 125. DSLAM 120 provides a standard interface between provider equipment and the CO termination of the communication lines. The termination is in the form of modules that plug into DSLAM 120 and contain multiple (8, 12, etc. ) ADSL modems, interfacing to an equal number of twisted pair lines. Broadband network 115 provides access to high-speed public or private networks such as the Internet. Public switched telephone network (PSTN) 125 provides basic ADSL communications system 100 with ability to access conventional voice telephone systems.

Transmission path 130 beginning at the CO DSLAM modem card output and terminating at the input to CPE modem 155 is the principal location for crosstalk noise coupling among lines. Main distribution frame (MDF) 135 is the central point within the CO at which all local loops terminate. Network termination equipment (NTE) 145 is most significant in large buildings where multiple instances of telephone line 140 bundled together are broken out and routed to the proper Customer Premise Equipment (CPE) modem within the building. Telephone line 140 represents a traditional voice plain old telephone service (POTS) line with loading coils removed and replaced by electrical short circuits.

CPE ADSL box 150 represents the communication system equipment located at individual customer premises. It includes ADSL modem 150 as well as high pass filter 160, low pass filter 165, and other circuitry necessary to provide both ADSL and POTS capability. Power is typically supplied by a low current, external power supply 170. CPE ADSL box 150 output interfaces are provided for computer 180 and telephone 185. Crosstalk Coupling Among Bundled Twisted Pair Lines

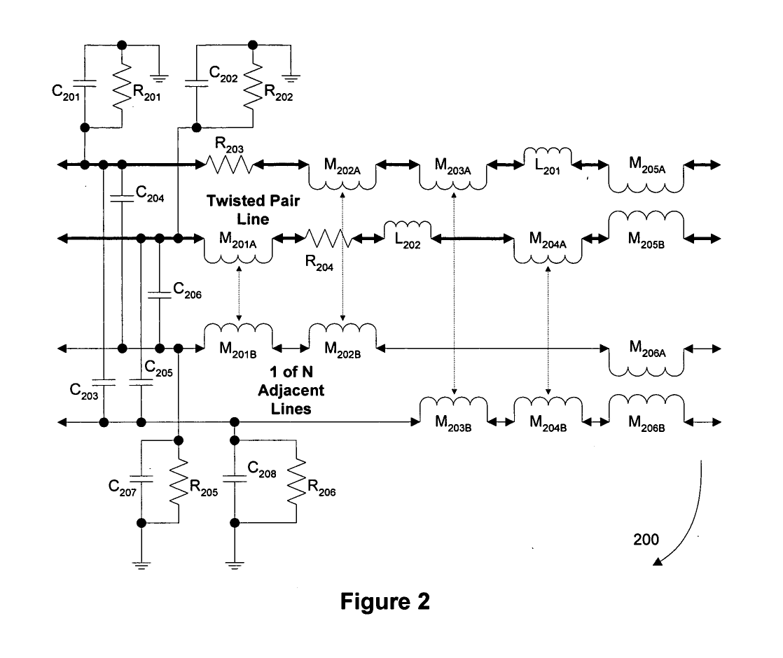

FIG. 2 is an illustration 200 of parasitic, lumped parameter, circuit elements that contribute to crosstalk noise coupling between individual transmission media located in close proximity. Close proximity typically meaning they are located within a bundle comprising multiple transmission media of the same type that may be transmitting signals of similar type, signals of totally different nature, or transmitting no signal at all. The transmitted signals may completely change type or not be present at different times. Illustration 200 shows only 2 twisted pairs due to the number and complexity of the media and paths for crosstalk noise coupling. The parasitic elements shown are replicated for and among each signal conductor within the bundle. The transmission media is a form of transmission line but illustration 200 does not depict a model representation of either the entire line or a unit length segment.

The most important general factor in crosstalk noise coupling is the presence of any imbalance between comparable parasitic elements coupling one line to each of the other two. If the parasitic coupling elements are balanced, the noise coupled will be common mode, typically easy to control, remove and which will not ultimately degrade the signal-to-noise of the system. Any imbalance between the values results in the conversion and coupling of a portion of the noise as differential noise. The receive circuit will detect and interpret differential noise to be part of the information transmitted. It is the differential crosstalk noise coupling that ultimately limits system performance to levels far below its potential capacity.

The following are the principle crosstalk noise coupling paths illustrated. Resistors R201, R202, R205, and R206 represent the DC leakage from each of the four lines to ground. The primary sources of this resistance are the insulation resistance and the dielectric loss in the wire insulation. The noise path is from a first line through its parasitic resistance to ground then through the parasitic resistance of a second line to ground into the second conductor. Most present xDSL systems do not bother to balance resistance to ground since the crosstalk coupling effects of parasitic capacitance overwhelm it.

Capacitors C201, C202, C207 and C208 are in parallel with respective resistors R201, R202, R205 and R206 and function in a similar manner. The capacitors are formed by the physical and electrical separation of one conductor and ground by dielectric material, principally the wire insulation. Differences in value result primarily from allowed manufacturing tolerances. Parasitic capacitance to ground is a far more significant coupling mechanism than the resistance and will become more so as future xDSL systems utilize greater bandwidth.

The most significant crosstalk coupling mechanism is the line-to-line parasitic capacitance represented by capacitors C203, C204, C205, and C206. Line-to-line parasitic capacitance is formed in the same manner as the capacitance to ground with ground being replaced by another signal wire.

In addition to crosstalk noise coupling via electric fields within parasitic capacitance, crosstalk noise is coupled through magnetic field coupling via parasitic mutual inductance between conductors. This is illustrated by mutual inductances M201A and B, M202A and B, M203A and B, and M204A and B. In addition to the mutual inductances between wire conductors, parasitic mutual inductance exists within common mode chokes and is represented by M205A and B, M206A and B.

The remaining sources are subtle but significant. Each line has inductance represented by inductors L201 and L202. Inductances of the second twisted pair line are not shown. Differential line inductance results in a phase shift to ground and relative time delay between the inverted and non-inverted signals on each twisted pair. At any point on the line at any point in time, the differential line inductance results in an amplitude difference that is coupled into the other pair even if the parasitic coupling capacitance is perfectly balanced.

Each line also has series resistance represented by resistors R203 and R204. Resistances of the second twisted pair line are not shown. Series resistances comprise a combination of DC resistance, skin loss, and radiation resistance. The last two are non-linear functions of the current in the line.

DC resistance variation results primarily from wire manufacturing tolerances. For example, in a twisted pair, the physical length of the smaller diameter wire will be longer because it will tend to wrap itself around the larger wire when it is twisted because it has less mechanical resistance to bending. At long distances this effect can add hundreds of feet to one of the pair of wires. At distances greater than 20,000 feet this difference can be more than 500 feet, measured. This difference in wire length combined with the lower cross-section yields a difference in resistance that is a significant source of common-mode signal. In addition, the difference in the characteristic impedance of each of the wires to virtual ground results in a difference in the loading and in the velocity of propagation along the two wires. At long distances the difference, at high data rates, can cause complete symbol overlap and the signal arriving at the normal differential input will appear to be 100% noise. If there is partial overlap, the common-mode can look to be inductive with respect to the differential signal confusing standard signal processing and analysis. This is another source for common-mode induced crosstalk.

Since any difference in resistive characteristics will result in differences in signal attenuation over the length of the line. Differing attenuation implies differences in signal amplitude that are coupled as differential crosstalk noise in a similar manner to inductance induced amplitude imbalance. Again, the crosstalk noise-coupling paths are linear with unchanged coupling coefficients even if the amounts of common mode and differential crosstalk noise vary in a non-linear manner with current.

Taken together, the parasitic elements depicted in FIG. 2 (illustration 200) form the principal crosstalk noise coupling paths between transmission media. Except in relatively minor points the depicted coupling paths between lines constitute a linear system wherein superposition is appropriately utilized. The major result is that it is not necessary to know the specific signals present on each line within a bundle to be able to cancel the crosstalk noise produced by them. It is sufficient to know the combination from all sources that is coupled. It also means that the common mode signal that must be present will include all coupled crosstalk noise so that it can be used as a reference in synchronous detection and noise correlation schemes.

Multiple Stage Crosstalk Noise Reduction System

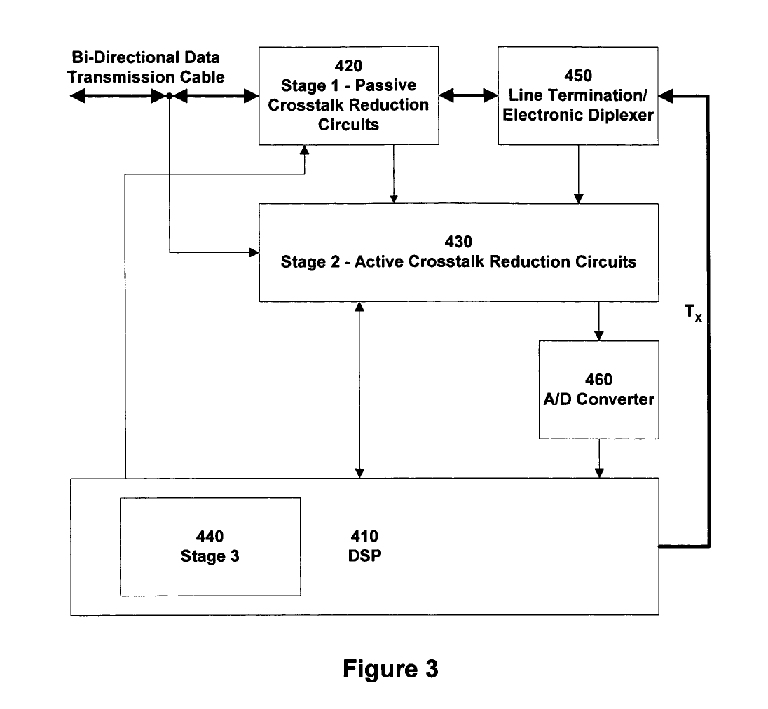

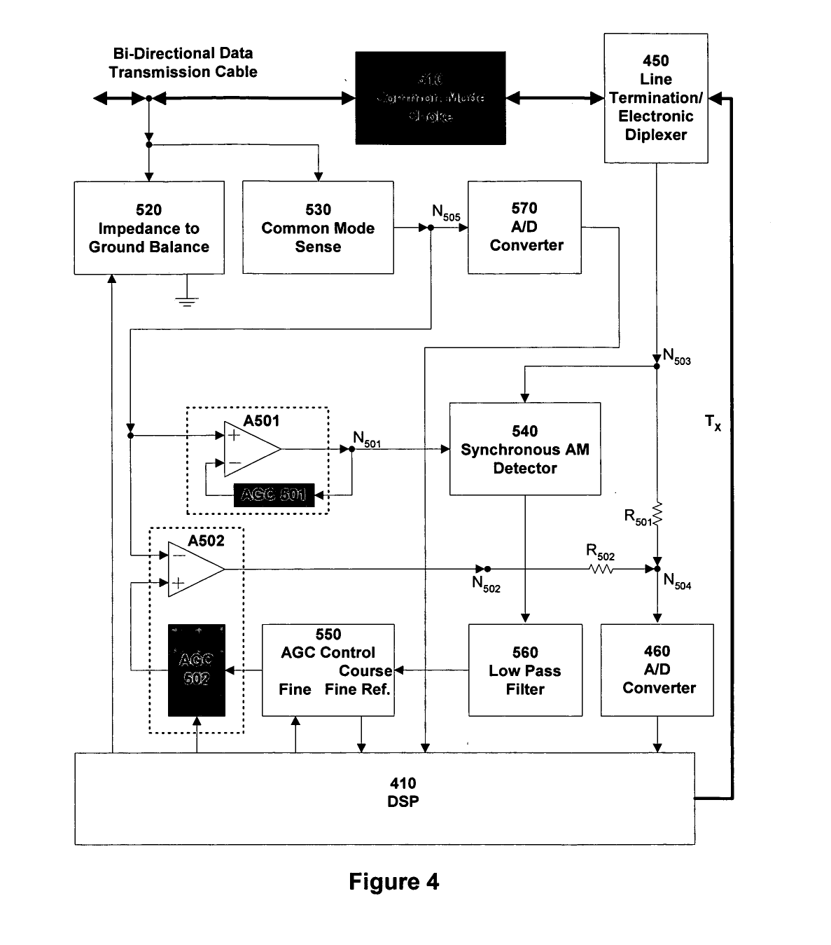

FIG. 3 is a block diagram of the crosstalk noise reduction system of the present invention illustrating the relationship among the three stages of crosstalk noise reduction that comprise it. Stage 1 (420) is comprised primarily of passive noise control elements. This does not imply that the entire Stage is passive. The means for adjusting the values of variable components such as resistors or capacitors may be or include active circuitry and will depend on the specific implementation of the variable components selected. Specific functions comprising Stage 1—passive crosstalk noise reduction circuits 420 are described in detail in the discussion of FIG. 4.

Stage 2 (430) is comprised primarily of active noise control circuitry in the form of a type I feedback control loop that generates an error signal which when combined with the received data signal effectively cancels a substantial portion of any differential crosstalk noise present in the received data signal. As with Stage 1, specific functions comprising Stage 2—active crosstalk noise reduction circuits 430 are described in detail in the discussion of FIG. 4.

Stage 3 (440) crosstalk noise reduction is accomplished primarily by signal processing within DSP 410. Stage 3 signal processing includes functions similar to that used in the present art that provides crosstalk noise reduction comparable to the present art. As such, no detailed description is included since a person skilled in the art can locate and implement any of numerous algorithms that perform this function and provide similar improvement in signal-to-noise ratio.

Among the main improvements in processing performance provided by the present invention is that the substantial reduction in crosstalk noise produced by stages 1 and 2 prevents the loss of significant resolution in the A/D conversion process. Thus signal processing noise reduction is performed on a signal that begins Stage 3 processing with both a lower noise level and higher signal to noise ratio.

Another major improvement of Stage 3 signal processing is the ability to utilize reference inputs not present in systems of the present art to further reduce crosstalk noise. For example, the Stage 3 digital sections utilize two inputs from two A/D converters 460 and 570 (the receive signal and common mode signal) and perform a complex Fast Fourier Transform (FFT) on each. A digital cross correlation then determines any remaining error in the transfer coefficient between common mode and differential. Stage 3 then takes this information and sends control signals back to analog Stage 2 to fine-tune the Active Gain Control (AGC) to further maximize crosstalk reduction. It should be noted that both the processing and AGC control signals are frequency dependent and thereby adjust the gain and error correction across the entire xDSL band.

Stage 3 also generates signals that control various aspects of stages 1 and 2. Whenever necessary and appropriate, the signals will be described and discussed as part of the discussion of the functions they control rather than collectively as part of a separate discussion of Stage 3.

Crosstalk Noise Reduction System

FIG. 4 is a block diagram of the analog portion of crosstalk noise reduction system of the present invention. FIG. 4 comprises stages 1 and 2 of the crosstalk noise reduction system of the present invention. Common mode choke 510 and impedance to ground 520 comprise Stage 1. The remaining functional blocks with the exception of DSP 410, line termination/electronic diplexer 450, and A/D converter 460 comprise Stage 2. In spite of the fact that DSP4 10 is not part of Stage 2, it plays a critical role in the operation of both Stage 1 and Stage 2 with its mathematical and signal processing and the generation of control signals for both stages.

The following are the principle functions with specifics of each typically described in detail in the relevant section below. Common mode sense 530 provides a real time measure of common mode signals present including crosstalk noise and serves as a reference for amplitude and phase information for the various analog and digital functions of the present invention. The output from common mode sense 530 at node N505 is passed to A/D converter 570 where it is converted to digital form and passed to DSP 410. The output from common mode sense 530 is also passed to the non-inverting input of amplifier A501 and the inverting input of amplifier A502.

Amplifier A501 possesses an internal, self-AGC function AGC 501, and provides a high amplitude common mode reference input to synchronous AM detector 540 at node N501. The output of synchronous AM detector 540 is a DC level that is filtered and stored by low pass filter 560. The output of low pass filter 560 is the AGC course adjust control signal that is pass to AGC control 550.

Amplifier A502 generates the crosstalk noise correction signal at node N502 that is combined with the receive signal at summing node N504 to cancel crosstalk noise. The receive signal and crosstalk noise correction signals are coupled into summing node N504 through resistors R501 and R502 respectively.

DSP 410 uses the AGC course adjust control signal, and other available noise and signal information to generate a fine adjust control signal that is passed to AGC control 550. Both course and fine AGC control signals are processed within AGC control 550 and used to set the DC level of AGC 502. DSP 410 also generates a control signal that shapes the frequency characteristics of amplifier A502 by shaping the frequency characteristics of AGC 502. The control signal is passed directly to AGC 502 from DSP 410.

Consideration for Other Sources of Noise

The present invention provides a means for significantly reducing crosstalk noise on twisted pair, Ethernet, polyphase and shielded wire systems. The embodiment illustrated presents noise vulnerability resulting from the fact that all of the common mode noise present does not result from crosstalk. Such noise can comprise reflection of both transmit and receive data signal, echoes and ingress noise and when sensed by the common mode sense signal can be injected through amplifier A502 directly onto the receive signal at node N504. It is critically important that this situation be addressed.

The first and not insignificant factor is that the architectural configurations of the entire modem can either mitigate or aggravate this situation. A discussion of the details of this is far too extensive and generally not pertinent to the present invention. It is important that a modem system architect address this factor along with his other design considerations.

Second, it is important to include a band pass filter (or series combination high pass and low pass filters) between node N502 and resistor R502. This filter will remove out of band noise and is important to prevent the noise from consuming the dynamic range of A/D converter 460.

Finally, it is necessary to address the major problem that is associated with in-band ingress noise. Simple, low cost filters with the capability to independently set the number of poles, attenuation level, pass band, and quality factor Q can be added in series and used to notch out large offending noise lines such as radio station transmissions. More complicated solutions involve the identification of noise and its sources and the addition of special circuitry and processing capability to mitigate it.

Stage 1 Crosstalk Noise Reduction System

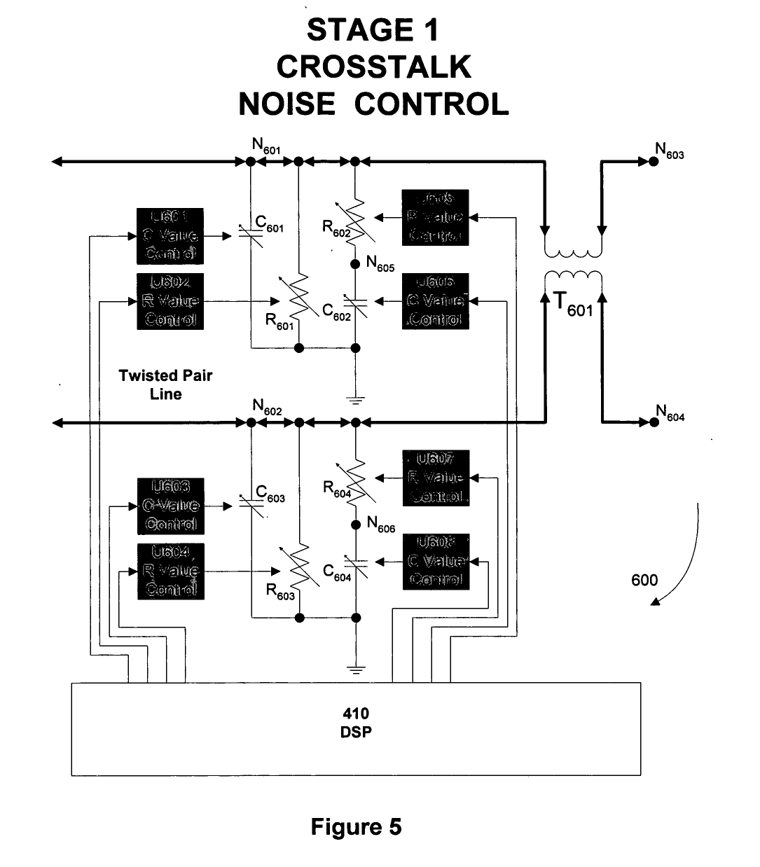

FIG. 5 is an illustration of an embodiment 600 of Stage 1 of the crosstalk noise reduction system of the present invention. The most significant element of Stage 1 is common mode choke 510 schematically represented by common mode choke T601. Present art xDSL systems use common mode chokes with a lower cutoff frequency of 40 to 50 MHz. The chokes primarily serve to remove RF and ingress noise. The high cutoff frequency has an additional benefit in that it keeps the choke small and low cost. Unfortunately, the low inductance that generates a high cutoff frequency allows in-band common mode noise to couple into the receive circuitry where numerous non-linear circuit elements such as semiconductor junctions are present to convert a portion to differential noise, thereby reducing the signal-to-noise ratio of the receiver circuit.

In the present invention, common mode choke T601 is the first and most significant component in the control and removal of common mode noise signals present on the system transmission media. Other major contributors to this are the line isolation transformer and use of electronic circuits with high common mode rejection such as instrumentation amplifiers in the receiver network. Although common mode noise is typically much less damaging to performance than differential noise, it is important to remove it because of the ease with which it can be converted to differential noise.

Common mode choke T601 performs a secondary function within Stage 1 by forcing the same current flow on each line. This reduces the impact of imbalance in mutual inductance and reduces the mutual inductance coupling coefficient between lines over the xDSL band. As a result, common mode choke T601 of the present invention should have an operating frequency band that overlaps the entire operating band of the particular xDSL system. Circuitry for impedance to ground balance 520 and common mode sense 530 are located on the line side of common mode choke T601.

Impedance to ground balance 520 provides the means to correct mismatched parasitic line to ground circuit characteristics as illustrated in FIG. 2. The resistors and capacitors are dynamically adjusted to minimize the NEXT associated with common mode in the present first Stage 1 circuit. Provided as an illustrative example is one implementation of Stage 1, further implementations of this function set is apparent to anyone skilled in the art. For example, variable capacitors C601 and C603 are in parallel with parasitic capacitors C201 and C202. They will typically be large enough to overcome the parasitic contribution and adjusted so that the capacitance to ground from each line is functionally identical. Capacitive balance is much more significant than resistance balance that is occasionally implemented in present art systems. The series resistor capacitor combinations are provided to help smooth anomalies appearing in balance across the frequency band. They may be omitted or multiple such networks in parallel may be employed based on the specific application and system performance objectives.

DSP 410 determines the values of variable resistors R601, R602, R603 and R604 and variable capacitors C601, C602, C603 and C604. Values are determined based on 3 data inputs. First is the output of common mode sense 530 converted to digital form by A/D converter 570. Second and third are the line to ground voltage on each line. Voltage sensors are not shown since they are not necessarily exclusive to the crosstalk noise reduction system of the present invention but can supply the signal amplitude information to the entire xDSL modem for multiple uses.

One embodiment of the line voltage sense circuit comprises precision resistor divider networks from each line to ground. Resistor ratios within and between the divider networks should be as tight as practical. The output of each divider is connected to its own sample-and-hold circuit for synchronized measurement of each line voltage. The 2 sample-and-hold circuit output signals are alternately switched to a single A/D converter that provides the data to DSP410. Changes in line amplitude resulting from component value changes are measured to allow rapid achievement of line-to-line balance.

Variable components may be implemented in a variety of manners that directly impact the form of controls U601 through U608. For example, variable resistors may be implemented with digital pots that typically provide 8-bit resolution with direct digital value selection. If it is desired to integrate the devices into a custom integrated circuit, resistors may be arrayed in a digital ladder and switched in and out of a parallel structure with analog FET switches. The latter approach may be directly applied to capacitors.

Common Mode Sense

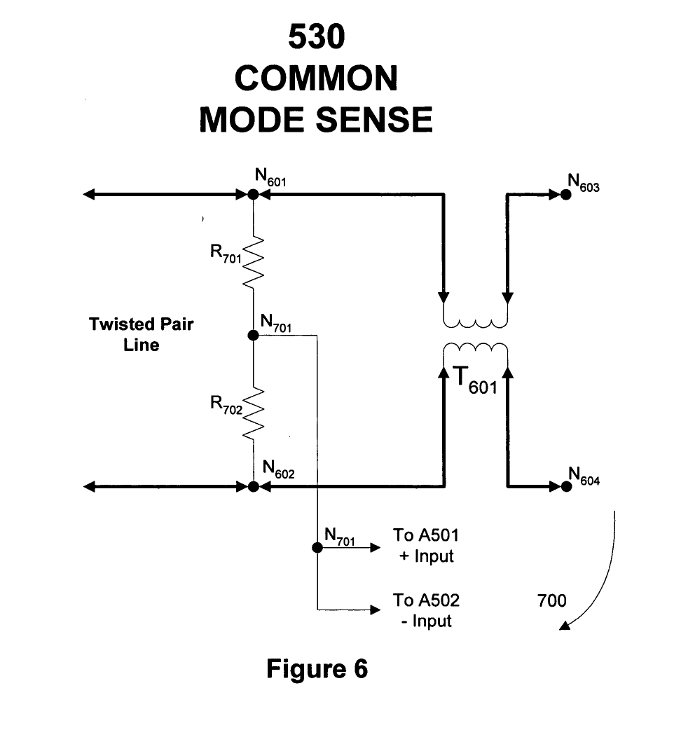

FIG. 6 is a circuit diagram of an embodiment 700 of the common mode sense function of Stage 2 of the crosstalk noise reduction system of the present invention for twisted pair transmission media. A common mode sense resistor network comprising resistors R701 and R702 detects common mode signals present on the twisted wire pair transmission media. The network is located on the line side of common mode choke T601 and any other components that filter or distort common mode noise entering the modem in order to provide a large signal, undistorted sample of the common mode noise, including crosstalk, present on the transmission media.

Specific resistance values for resistors R701 and R702 are not critical. They should be large enough so as not to load the transmission media. For xDSL type systems, a value in the range of 10K to 100K is generally suitable. Absolute resistor tolerances are also of secondary importance. Tolerances of +/−0. 1% are typically recommended for the hybrid line interface networks and are not expensive to fabricate or use. This tolerance will be more than adequate for this application but may make it easier to realize the primary design criteria. The important network design criteria are the realization and maintenance of a very tight ratio of 1.0000 between the resistor values. The maximum ratio tolerance for XDSL systems is approximately +/−0.01%. A ratio of +/−0.001% is a preferred design objective, and an even tighter tolerance can benefit the highest performance systems. Implementation of each resistor using networks with multiple resistors may simplify realization of tight ratios in a low cost manufacturing environment.

Resistor R701 couples the first transmission wire of the pair at node N601 to node N701. Resistor R702 couples the second transmission wire of the pair at node N602 to node N701. The voltage at node N701 constitutes the common mode signal present on the twisted pair transmission media. Node N701 is coupled to the remainder of Stage 2 of the crosstalk noise reduction system at the non-inverting input of common mode reference amplifier A501 and the inverting input of crosstalk correction amplifier A502.

The embodiment shown is directed to a twisted wire pair signal transmission media such as xDSL and including the ADSL system illustrated in FIG. 1. For systems operating at significantly higher frequencies and bandwidths, it may be necessary to replace the simple resistor network with a compensated circuit to mitigate the effects of parasitic network elements at high frequencies. For systems such as Ethernet that use multiple pairs and polyphase systems, the approach taken also will depend upon the desired system performance level. Worst case, for achievement of the highest level of system performance, each pair of wires can have its own crosstalk noise reduction system in accordance with the present invention. Even with maximum integration into custom integrated circuits, this approach can be complex and costly. For most applications in which individual wires or wire pairs are twisted together, common mode crosstalk noise will be similar in each individual set and it will be sufficient to modify the resistor network of FIG. 6 to have additional resistors coupling the additional transmission media conductors to node N701.

Synchronous AM Detector

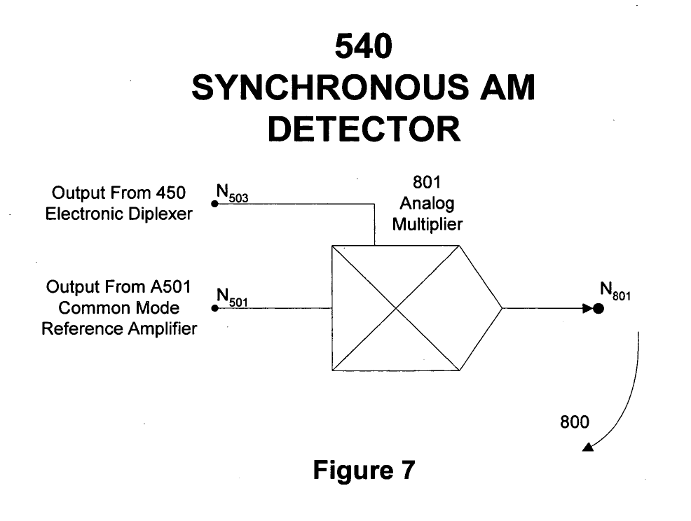

FIG. 7 illustrates an embodiment 800 of synchronous AM detector 540 of Stage 2 of the crosstalk noise reduction system of the present invention. Embodiment 800 consists of an analog signal multiplier circuit. The first analog input signal is the output from common mode reference amplifier A501 and is coupled to synchronous AM detector 540 at node N501. The second analog input signal is the total received signal, is the output from line termination/electronic diplexer 450 and is coupled to synchronous AM detector 540 at node N503. The total received signal comprises the transmitted information signal originating at the remote end of the transmission media and noise (including differential crosstalk noise) prior to its conversion to digital format.

The output from embodiment 800 of synchronous AM detector 540 is an analog signal representing the summation of instantaneous output signals at all frequencies within the operating frequency band of analog multiplier U801. At any specific frequency within the operating band, the instantaneous output signal is of the form AB cos θ, where A is the instantaneous amplitude of the input signal at node N501 at the frequency, B is the instantaneous amplitude of the input signal at node N503 at the frequency, and θ is the phase angle between the 2 the input signals at the frequency. The output from analog multiplier U801 is coupled to the low pass filter input at node N801.

An alternate embodiment converts the two analog input signals to digital form and then carries out the synchronous detection (multiplication) and following low pass filter and AGC control functions digitally. The digital output of this process is the crosstalk noise cancellation signal that must then be reconverted to analog and passed to crosstalk correction amplifier A502. The major difficulties with this type of digital embodiment are the added conversions required between digital and analog signal formats. These are among the most expensive and technically limited functions, and they produce a loss of signal information due to the resolution limits of the conversion processes. Use of an analog synchronous detection scheme is the preferred approach.

Low Pass Filter

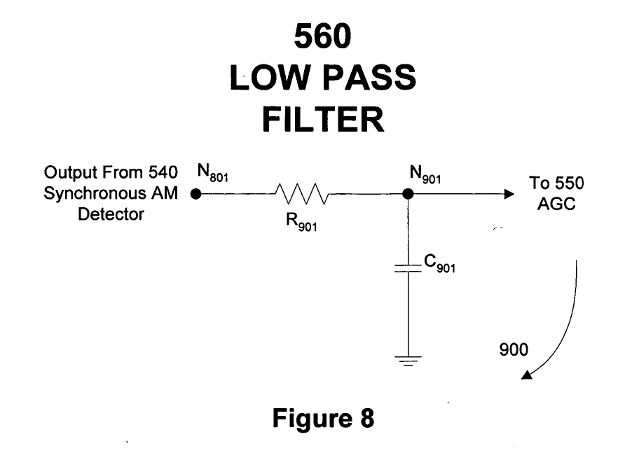

FIG. 8 illustrates an embodiment 900 of low pass filter 560 of Stage 2 of the crosstalk noise reduction system of the present invention. The preferred embodiment for low pass filter 560 is a simple single resistor, single capacitor circuit. The output signal from synchronous AM detector 540 is coupled to the input of low pass filter 560 at node N801. Resistor R901 couples low pass filter 560 input at node N801 to output at node N901. Capacitor C901 couples low pass filter output at node N901 to ground.

Low pass filter 560 performs three functions, only one of which is the classic filter function. The first function is integration of the output signal of synchronous AM detector 540. Integration is performed by capacitor C901. Since the output signal, described in the synchronous AM detector section above, includes a factor that depends upon the phase angle between the input signals to synchronous AM detector 540, synchronous signals will contribute to the output since all other signal components will integrate to zero over time. Since common mode noise present on the transmission media is heavily attenuated before generation of the receive signal at node N503, the output signal at node N901 provides a measure of the amplitude of differential crosstalk noise coupling into the transmission media that directly contributes to a reduced signal-to-noise ratio for the xDSL receiver system. This measure of differential crosstalk is used for two purposes. First, it is used to help set the value of the components within impedance to ground balance 520 since proper balance will result in minimum differential crosstalk noise coupling through the components and line-to-ground parasitic elements. Second it is used in setting the gain and AGC level for crosstalk correction amplifier A502 to achieve cancellation of residual differential crosstalk noise present in the receive signal before it is converted to digital format.

The second function of low pass filter 560 is to serve as an analog memory element, a function again performed by capacitor C901. Since the crosstalk noise-coupling paths illustrated in FIG. 2 can only change value at very low rates, the DC level at node N901 is significant to the performance of the first function discussed above. Capacitor C901 both substantially maintains the appropriate DC level reflecting the differential crosstalk coupling level and allows the DC level to be slowly varied with environmental changes particularly temperature. The change rate is limited by the time constant formed by the combination of resistor R901 and capacitor C901, the time constant being much lower than any potential changes in the elements shown in FIG. 2.

The third function of low pass filter 560 is that of a traditional low pass filter. Since the DC value of the output is used, it is extremely valuable to the system to filter out any high frequency noise or spikes coupling into the circuit from the transmission media through synchronous AM detector 540. The bandwidth of the filter may be very narrow, but in practice it should be increased to at least two hundred hertz. Filter attenuation can then rise to near the bottom of the XDSL band if properly designed. The wider bandwidth allows the filter to be implemented with small components, saving valuable space on CPE modem and CO DSLAM circuit boards.

Automatic Gain Control

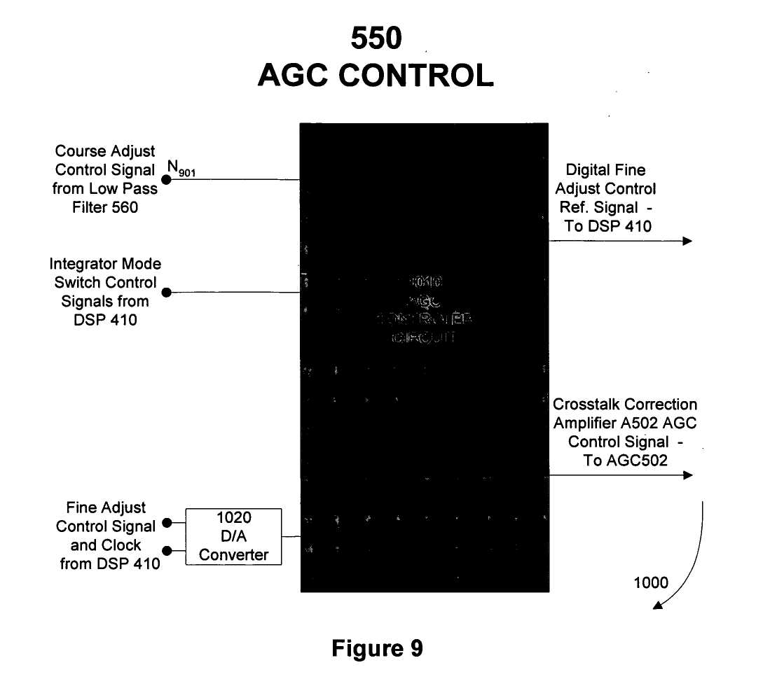

FIG. 9 is a block diagram of an embodiment 1000 of AGC 550 of Stage 2 of the crosstalk noise reduction system of the present invention. The principal function of AGC 550 is the generation of an analog signal that controls AGC 502 and thereby sets the amplitude of the output of crosstalk correction amplifier A502 AGC so as to cancel residual differential crosstalk noise at node N504. The preferred embodiment for typical xDSL applications utilizes 2 levels of control and adjustment in the generation of the control signal, a course adjust and fine adjust. This 2 level adjustment allows AGC 550 to operate open loop in that it makes no direct use of the output signal of crosstalk correction amplifier A502 whereas in typical AGC amplifier applications, the amplifier output is the principal input data and control signal for the AGC circuit. Open loop operation avoids the risks of oscillation and instability present with closed loop systems. However, alternate embodiments can utilize closed loop operation and the selection is subject to engineering judgment based on the requirements of the specific application. Generation of the analog signal that controls AGC 502 is an internal function of AGC controller 1010.

Embodiment 1000 has two data inputs and two output signals. The first data input signal is the analog output from low pass filter 560 at node N901 referred to as the course adjust control signal. The second data input signal is the fine adjust control signal, a digital signal generated by DSP 410. This signal is converted to analog form by A/D converter 1020 before being transmitted to AGC controller 1010. In addition to the fine adjust control signal, DSP 410 provides several control signals that are used by functions internal to AGC controller 1010.

AGC Controller

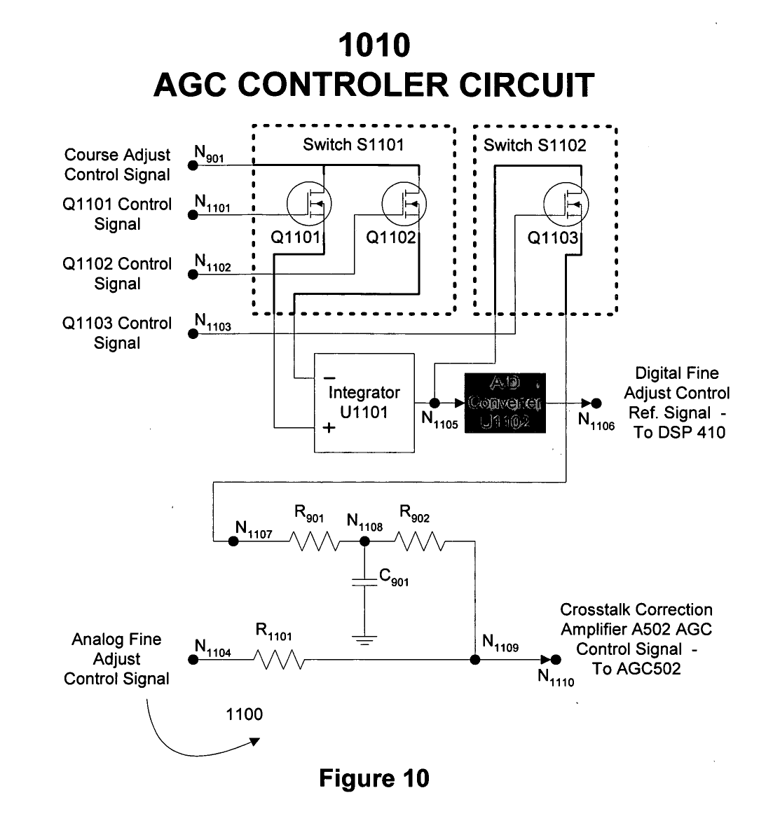

FIG. 10 illustrates an embodiment 1100 of AGC controller 1010 of AGC 560 of Stage 2 of the crosstalk noise reduction system of the present invention. The principle data input to AGC controller 1010 is the course adjust control signal at node N901. As previously described in the discussion of the functions of low pass filter 560, the signal is a DC level representing the level of differential crosstalk coupling into the transmission media. The signal can be passed through analog switches Q1101 or Q1102 to either the inverting or non-inverting input to integrator U1101. Q1101 or Q1102 can also block the signal from either integrator input if both are simultaneously in their off state thereby stopping the integration process and providing a hold capability for the entire system.

The primary function of integrator U1101 is in the location and maintenance of operation at a point of maximum differential crosstalk noise cancellation in the receive signal at node N504. This is accomplished by integrating the DC course adjust control signal at node N901, which also changes the AGC level of AGC 502 and the resulting differential noise cancellation signal injected at node N504. Present and previous values of the voltage at node N1106 are compared. If the level declines, integration continues in the same direction until the value increases. The direction of integration is then reversed until the optimum operating point is reached where the system is placed in a hold condition by opening both analog switches Q1101 and Q1102.

A secondary function of integrator U1101 is the addition of gain to the loop generating the noise cancellation signal injected at node N504. This loop includes the course level setting portion of crosstalk correction amplifier A502 AGC control signal that also includes a fine correction signal. The course level signal is formed from the output of integrator U1101 at node N1105. Analog switch Q1103 provides the capability to open the course signal loop without removal of the digital fine adjust control ref. signal at node N1106 that is continuously required by DSP 410. The switched course signal at node N1107 is passed to a low pass filter formed by resistor R901 and capacitor C901. Except for possible minor value changes, this filter is virtually identical in form and function to low pass filter 560 described previously. The filter output at node N1108 constitutes the course control signal component for setting the DC gain of AGC 502.

The fine component of AGC 502 control signal is generated by DSP 410, converted to analog form by D/A converter 1020, and combined with the course level setting component at summing node N1109. The course component is injected through resistor R902 and the fine component through resistor R1101. DSP 410 generates the fine component of A502 AGC control signal using present and previous values of digital fine adjust control reference signal at node N1106, which comprises a sample of the output signal of integrator U1101 that has been converted to digital form by slow A/D converter U1102.

It should be noted that the crosstalk correction amplifier A502 AGC control signal generated by and within AGC controller circuit 1010 comprises the DC portion of the signal setting the AGC level for crosstalk noise correction amplifier A502. The required amplitude of the noise cancellation signal to be injected at node N504 is frequency dependent, so that the gain of the amplifier set by AGC 502 must also be frequency dependent across the xDSL operating band. The frequency dependency is generated by DSP 410 from its multiple data inputs including the frequency and phase information present in the common mode sense input provided by A/D converter 570. The frequency dependent control signal is provided directly to AGC 502 from DSP 410 as illustrated in FIG. 4. The form and any subsequent conversion of the frequency dependent control signal would depend upon the specific configuration of the circuitry adopted for implementation of AGC 502.

Thus, a system for crosstalk noise reduction on twisted pair, Ethernet, polyphase and shielded wire systems has been described. The embodiments of the present invention are defined by the following claims and their full scope of equivalents.

1. An crosstalk noise reduction system comprising:
a first stage, comprising passive crosstalk noise reduction circuits operating on signals from a transmission media;
a second stage, comprising active crosstalk noise reduction circuits and multiple feedback loops; and
a third stage, comprising a digital signal processor.

2. The crosstalk noise reduction system of claim 1 wherein said first stage is configured to filter common mode noise from a transmission media and balance the resistive and reactive parasitic electrical characteristics of said transmission media that couple each line.

3. The crosstalk noise reduction system of claim 1 wherein said second stage is configured to perform differential crosstalk noise reduction in real time.

4. The crosstalk noise reduction system of claim 1 wherein said third stage is configured to reduce residual crosstalk after analog-to-digital conversion.

5. The crosstalk noise reduction system of claim 1 wherein said third stage digitally controls said crosstalk noise reduction system and portions of subsystems of said second stage.

6. The crosstalk noise reduction system of claim 5 wherein said third stage uses two inputs from said first and second stage to adjust control signals sent to calibrate components in said second stage.

7. The crosstalk noise reduction system of claim 6 wherein the first of said two inputs is from an A/D converter converting a receiving signal from in transmission media and the second of said two inputs is from an A/D converter converting a common mode signal in said transmission media.

8. The crosstalk noise reduction system of claim 1 wherein said second stage further comprises:
a common mode sense;
an A/D converter;
a first amplifier receiving output signal from said common mode sense;
a second amplifier receiving output signal from said common mode sense; and
a synchronous AM detector.

9. The crosstalk noise reduction system of claim 8 wherein said second stage further comprises:
a summing node configured to use output from said second amplifier to cancel crosstalk noise in a receiving signal from said transmission media.

10. The crosstalk noise reduction system of claim 9 wherein said second stage further comprises:
an AGC control configured to receive control signals from said third stage to control said second amplifier.
